(19) United States
(12) Patent Application Publication
(10) Pub. No.: US 2015/0220713 A1
(43) Pub. Date: Aug. 6, 2015

(54) DYNAMIC ACCOUNT AUTHENTICATION USING A MOBILE DEVICE

(71) Applicant: III HOLDINGS 1, LLC, WILMINGTON, DE (US)

(72) Inventors: Blayn W. Beenau, Peoria, AZ (US); William J. Gray, Peoria, AZ (US); Jeffrey D. Langus, New York, NY (US); David P. Whittington, Brighton (GB)

(21) Appl. No.: 14/691,188

(22) Filed: Apr. 20, 2015

Related U.S. Application Data
(63) Continuation of application No. 12/111,381, filed on Apr. 29, 2008.

(51) Int. Cl. G06F 21/31; G06F 21/45

(52) U.S. Cl. CPC G06F 21/316; G06F 21/45

(57) ABSTRACT

Providing dynamic authentication of a user requesting access to a system via a mobile device is disclosed. An account holder tailors a set of customized security challenges and responses. When a request for account authentication is received from a mobile device, the system conducts a multi-step user authentication process that includes dynamically selecting and prompting the user with the custom security challenges.

### FIELD OF THE INVENTION

The present invention generally relates to increasing security and customer satisfaction during a user authentication process, and more particularly, to using dynamic challenge and response techniques to authenticate a mobile device and/or its users in order to access customer accounts.

### BACKGROUND OF THE INVENTION

In recent years, certain customer interactions and customer facing processes have been automated to increase efficiency and reduce companies' operational costs. Furthermore, in order to reach new customers and provide enhanced service to existing customers, companies often provide multiple methods that enable a customer to communicate with, and interact with, the company. For instance, a company may provide the ability to sign up for new services through a mail-in post card, a toll free telephone number, using a personal computer or using a mobile communications device.

As the number of methods and technical interfaces for communicating and initiating actions with a company increases, concerns about security also increase. Security is a concern for both the customer and the company. Companies lose substantial amounts of money each year due to fraudulent transactions. Furthermore, individuals have become increasingly sensitive to identity theft concerns. To address the increase in security concerns, companies have devised various technologies (e.g. encryption) and methods (e.g. credit card verification codes) to both decrease the risk of fraud and increase customer confidence and comfort associated with interfacing with the company.

Existing customer authentication methods typically constrain both the level of security and the customer comfort during the process. A long-felt need exists to enhance the customer authentication process to allow for full customization and dynamic selection of security challenges.

### SUMMARY OF THE INVENTION

The present invention improves upon existing systems and methods by providing a tangible, integrated, customized and dynamic customer authentication process. When a customer wishes to access an account held with a company, such as a financial transaction account, the system facilitates a multi-step authentication process. For instance, in one embodiment the customer may wish to use a mobile device to enroll in a new service associated with an existing account. The system allows customers to tailor and customize a set of security challenges (e.g. security questions) associated with their account. The system prompts the user for data that validates that the user has access to, or authorized usage of, a particular account. The system then dynamically selects a security challenge that has been customized by the customer (i.e. the account holder), prompts the user for an answer and compares the user's answer with the answer previously designated by the customer.

In one embodiment, an enhanced system for authenticating users to customer accounts uses dynamic challenge and response techniques to increase security and customer satisfaction. The system includes dynamic authentication of a user that accesses the system via a mobile device. The system receives a request from the mobile device for authentication of the user. The request includes information that uniquely identifies an account. The system sends a custom security challenge that is selected from security challenges that were previously customized and designated by the account holder. The system receives a response to the security challenge from the mobile device and compares the response to the valid responses designated by the account holder during the security challenges customization process. The customer authenticates the user to use the mobile device to conduct further actions associated with the account.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is an overview of a representative system for authenticating customer account holders using a mobile device, in accordance with one embodiment of the present invention.

FIG. 2 is a representative process flow diagram for using dynamic challenge and response techniques to increase security and customer satisfaction during the authentication process, in accordance with one embodiment of the present invention.

### DETAILED DESCRIPTION OF EXEMPLARY EMBODIMENTS

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, the system includes a graphical user interface (GUI), a software module, logic engines, numerous databases and computer networks. While the system may contemplate upgrades or reconfigurations of existing processing systems, changes to existing databases and business information system tools are not necessarily required by the present invention.

The exemplary benefits provided by this invention include enhanced confidence, security, convenience and transaction account (“TXA”) spending. For account issuers and processors, benefits include, for example, reducing the risk of allowing fraudulent modifications to a customer's TXA by requesting customer specific information. The system includes an automated authentication process and an enhanced customer value by providing a long-felt need to add partial or complete security for the authentication process. TXA issuers and processors also benefit from this invention due to increased likelihood of successful setup of new products and services, and hence a higher transaction success rate. Customer benefits include time-savings and convenience by eliminating or reducing manual and/or inefficient authentication methods and by enabling additional customer interfaces (i.e. “form factors”), such as mobile devices, to be authenticated for use by customer in accessing account services. Furthermore, the customer benefits from the comfort of responding to their own tailored security challenges and the confidence that they are dealing with a trusted service provider (e.g. a TXA issuer with which they have an account).

While described in the context of systems and methods that a more secure and efficient customer authentication for a service enrollment process, practitioners will appreciate that the present invention may be similarly used to enhance functionality, improve user satisfaction, increase speed, and reduce the risk of fraud in the context of providing authentication services and tools for anything that includes authentication or validation and/or that would benefit from automating an authentication process. Other embodiments of such authentication automation techniques may be accomplished through a variety of computing resources and hardware infrastructures.

While the description makes reference to specific technologies, system architectures and data management techniques, practitioners will appreciate that this description is but one embodiment and that other devices and/or methods may be implemented without departing from the scope of the invention. Similarly, while the description makes frequent reference to a web client, practitioners will appreciate that other examples of customer authentication and service enrollment functions may be accomplished by using a variety of user interfaces including personal computers, kiosks, handheld devices such as personal digital assistants and cellular telephones.

“Entity” may include any individual, consumer, customer, group, business, organization, government entity, transaction account issuer or processor (e.g., credit, charge, etc), merchant, consortium of merchants, account holder, charitable organization, software, hardware, and/or any other entity.

An “account”, “account number” or “customer account” as used herein, may include any device, code (e.g., one or more of an authorization/access code, personal identification number (“PIN”), user profile, demographic, Internet code, other identification code, and/or the like), number, letter, symbol, digital certificate, smart chip, digital signal, analog signal, biometric or other identifier/indicia suitably configured to allow the consumer to access, interact with, be identified by or communicate with the system. The account number may optionally be located on or associated with a rewards card, charge card, credit card, debit card, prepaid card, telephone card, secure hardware area or software element associated with a phone or mobile device, embossed card, smart card, magnetic stripe card, bar code card, transponder, radio frequency card or an associated account. The system may include or interface with any of the foregoing cards or devices, or a fob having a transponder and RFID reader in RF communication with the fob. Although the system may include a fob embodiment, the invention is not to be so limited. Indeed, the system may include any device having a transponder which is configured to communicate with an RFID reader via RF communication. Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc.

The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a fifteen-digit format will generally use three-spaced sets of numbers, as represented by the number “0000 000000 00000”. The first five to seven digits are reserved for processing purposes and identify the issuing bank, card type, etc. In this example, the last (fifteenth) digit is used as a sum check for the fifteen digit number. The intermediary eight-to-eleven digits are used to uniquely identify the customer. A merchant account number may be, for example, any number or alpha-numeric characters that identify a particular merchant for purposes of card acceptance, account reconciliation, reporting, or the like.

A “transaction account” (“TXA”) includes any account that may be used to facilitate a transaction, e.g. financial, loyalty points, rewards program, access, exchange, etc. A “TXA issuer” includes any entity that offers TXA services to customers.

A “TXA issuer” may include any entity which processes transactions, issues accounts, acquires financial information, settles accounts, conducts dispute resolution regarding accounts, and/or the like.

A “customer” includes any entity that has a TXA with a TXA issuer.

“TXA identification data” (“TXA-ID”) includes data used to identify, coordinate, verify or authorize a customer. The TXA-ID may also provide unique identification, validation and/or unique authorization. The TXA-ID may include, for example, a code, authorization code, validation code, access code, a transaction account identification number, demographic data, encryption key, proxy account number, PIN, Internet code, card identification number (CID), number, letter, symbol, digital certificate, smart chip, digital signal, analog signal, RFID, biometric or other identifier/indicia suitably configured to uniquely identify a customer and associated TXA and/or to authorize a transaction to a TXA. A CID number is used in many credit or charge card transaction accounts. For further information regarding CIDs see, for example: Systems and Methods for Authorizing a Transaction Card, U.S. Pat. No. 6,182,894 issued on Feb. 5, 2001; and System and Method for Facilitating a Financial Transaction with a Dynamically Generated Identifier, U.S. Ser. No. 11/847,088 filed on Aug. 29, 2007, both of which are hereby incorporated by reference.

A “user” 105 may include any individual or entity that interacts with system 101. User 105 may perform tasks such as requesting, retrieving, receiving, updating, analyzing, entering and/or modifying data. User 105 may be, for example, a customer enrolling in or modifying options for a product or service offered by a TXA issuer. User 105 may interface with Internet server 125 via any communication protocol, device or method discussed herein, known in the art, or later developed. In one embodiment, user 105 may interact with CIS 115 via an Internet browser at a mobile web client 110.

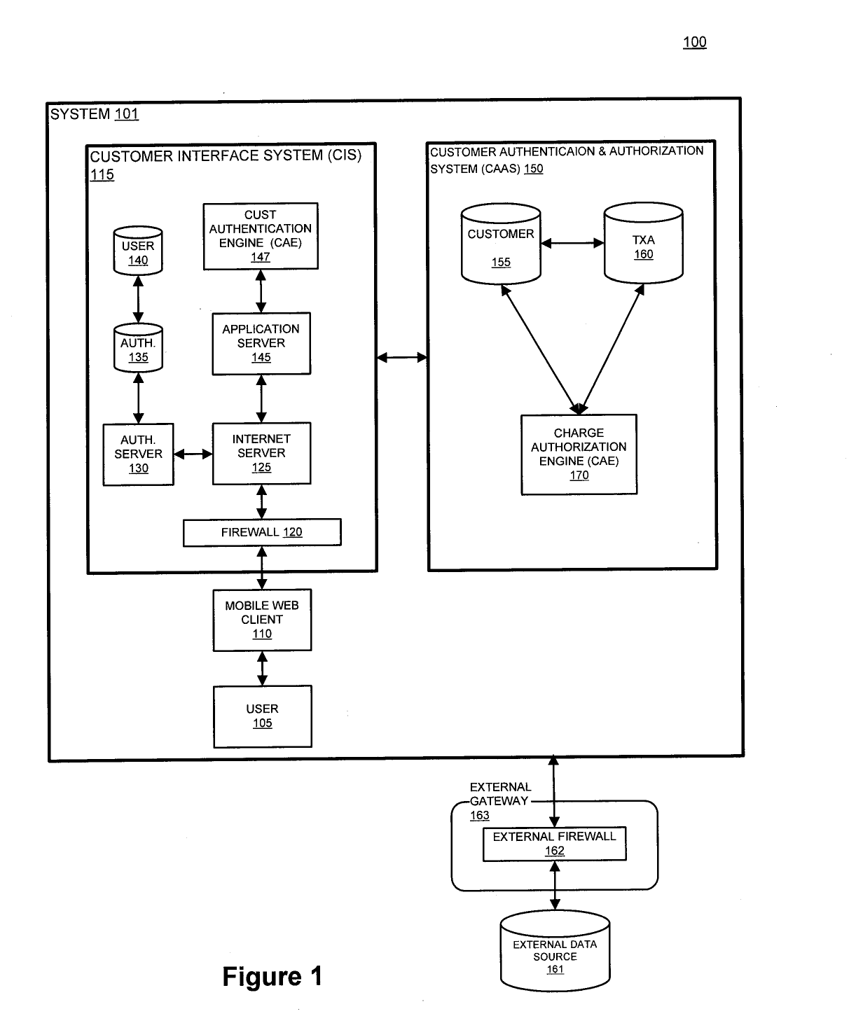

In one embodiment, with reference to FIG. 1, the system includes a user 105 interfacing with a customer interface system (“CIS”) 115 by way of a mobile web client 110. Mobile web client 110 comprises any hardware and/or software suitably configured to facilitate requesting, retrieving, updating, analyzing, entering and/or modifying data. The data may include verification data, authentication data, service enrollment data or any information discussed herein. Mobile web client 110 includes any mobile device (e.g., mobile phone), which communicates (in any manner discussed herein) with the CIS 115 via any network discussed herein. Such browser applications comprise Internet browsing software installed within a computing unit or system to conduct online transactions and communications. These computing units or systems may take the form of mobile phones, personal digital assistants, mobile email devices, laptops, notebooks, hand held computers, portable computers, kiosks, and/or the like. Practitioners will appreciate that the mobile web client 110 may or may not be in direct contact with the CIS 115. For example, the mobile web client 110 may access the services of the CIS 115 through another server, which may have a direct or indirect connection to Internet server 125.

The invention contemplates uses in association with customer enrollment systems, TXA services, customer service systems, customer portals, billing payment management systems, business intelligence systems, reporting systems, web services, pervasive and individualized solutions, open source, biometrics, mobility and wireless solutions, commodity computing, grid computing and/or mesh computing. For example, in an embodiment, the mobile web client 110 is configured with a biometric security system that may be used for providing biometrics as a secondary form of identification. The biometric security system may include a transaction device and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

The user 105 may communicate with the CIS 115 through a firewall 120 to help ensure the integrity of the CIS 115 components. Internet server 125 may include any hardware and/or software suitably configured to facilitate communications between the mobile web client 110 and one or more CIS 115 components.

Authentication server 130 may include any hardware and/or software suitably configured to receive authentication credentials, encrypt and decrypt credentials, authenticate credentials, and/or grant access rights according to pre-defined privileges attached to the credentials. Authentication server 130 may grant varying degrees of application and data level access to users based on information stored within the authentication database 135 and the user database 140.

Application server 145 may include any hardware and/or software suitably configured to serve applications and data to a connected mobile web client 110. The customer authentication engine “CAE” 147 is configured to perform customer validation and authentication functions. These functions include, for example, validating customer TXA, prompting user 105 with security challenges, verifying user responses, authenticating the user, initiating a service enrollment process, initiating other business modules, encrypting and decrypting. Additionally, CAE 147 may include any hardware and/or software suitably configured to receive requests from the mobile web client 110 via Internet server 125 and the application server 145. CAE 147 is further configured to process requests, execute transactions, construct database queries, and/or execute queries against databases within system 101, external data sources and temporary databases, as well as exchange data with other application modules (not pictured). In one embodiment, the CAE 147 may be configured to interact with other system 101 components to perform complex calculations, retrieve additional data, format data into reports, create XML representations of data, construct markup language documents, and/or the like. Moreover, the CAE 147 may reside as a standalone system or may be incorporated with the application server 145 or any other CIS 115 component as program code.

Customer authentication and authorization system (“CAAS”) represents the databases of record for a company, the TXA issuer transaction engine and other legacy systems, databases and modules. CAAS provides CAE 147 with the data to process a customer authentication and or charge authorization.

Charge authorization engine (“CAE”) 170 coordinates, authorizes and executes charges to TXAs. In one embodiment CAE 170 participates in the customer authentication process by, for example, executing an authorization transaction, providing information on recently authorized transactions, etc. CAS 170 communicates with other system 101 components such as the CIS 115 and TXA database 160.

FIG. 1 depicts databases that are included in an exemplary embodiment of the invention. A representative list of various databases used herein includes: an authentication database 135, a user database 140, a customer database 155, a TXA database 160, an external data source 161 and/or other databases that aid in the functioning of the system. As practitioners will appreciate, while depicted as a single entity for the purposes of illustration, databases residing within system 101 may represent multiple hardware, software, database, data structure and networking components.

Authentication database 135 may store information used in the authentication process such as, for example, user identifiers, passwords, access privileges, user preferences, user statistics, and the like. The user database 140 maintains user information and credentials for CIS 115 users. The customer database 155 stores profile, demographic and other information for a customer such as, for example, customized security challenges and responses, customer demographic information, authorized merchant information, rewards program information and any other information that enables making charges to a TXA. The TXA database 160 stores financial transactions. As practitioners will appreciate, embodiments are not limited to the exemplary databases described above, nor do embodiments necessarily utilize each of the disclosed exemplary databases.

In addition to the components described above, system 101, CIS 115, and CAAS 150 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 101 components may be embodied as a customization of an existing system, an add-on product, upgraded software, a stand-alone system (e.g., kiosk), a distributed system, a method, a data processing system, a device for data processing, and/or a computer program product. Accordingly, individual system 101 components may take the form of an entirely software embodiment, an entirely hardware embodiment, or an embodiment combining aspects of both software and hardware. Furthermore, individual system 101 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Mobile web client 110 includes an operating system (e.g., Windows Mobile OS, Windows CE, Palm OS, Symbian OS, Blackberry OS, J2ME, Window XP, Windows NT, 95/98/2000, XP, Vista, OS2, UNIX, Linux, Solaris, MacOS, etc.) as well as various conventional support software and drivers typically associated with mobile devices and/or computers. Mobile web client 110 can be in any environment with access to any network, including both wireless and wired network connections. In an embodiment, access is through a network or the Internet through a commercially available web-browser software package. Mobile web client 110 may be independently, separately or collectively suitably coupled to the network via data links which includes, for example, a connection to an Internet Service Provider (ISP) over the local loop as is typically used in connection with standard wireless communications networks and/or methods, modem communication, cable modem, Dish networks, ISDN, Digital Subscriber Line (DSL), see, e.g., Gilbert Held, Understanding Data Communications (1996), which is hereby incorporated by reference. In another embodiment, any portion of mobile web client 110 is partially or fully connected to a network using a wired (“hard wire”) connection. As those skilled in the art will appreciate, mobile web client 110 and/or any of the system components may include wired and/or wireless portions.

Firewall 120, as used herein, may comprise any hardware and/or software suitably configured to protect the CIS 115 components from users of other networks. Firewall 120 may reside in varying configurations including stateful inspection, proxy based and packet filtering, among others. Firewall 120 may be integrated as software within Internet server 125, any other system components, or may reside within another computing device or may take the form of a standalone hardware component.

Internet server 125 may be configured to transmit data to the mobile web client 110 within markup language documents. As used herein, “data” may include encompassing information such as commands, queries, files, data for storage, and/or the like in digital or any other form. Internet server 125 may operate as a single entity in a single geographic location or as separate computing components located together or in separate geographic locations. Further, Internet server 125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Like Internet server 125, the application server 145 may communicate with any number of other servers, databases and/or components through any means known in the art. Further, the application server 145 may serve as a conduit between the mobile web client 110 and the various systems and components of the CIS 115. Internet server 125 may interface with the application server 145 through any means known in the art including a LAN/WAN, for example. Application server 145 may further invoke software modules such as the CAE 147 in response to user 105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (http://yahoo.com/stockquotes/ge) and an internet protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In an embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second parties. Each of the three data sets in this example may contain different information that is stored using different data storage formats and/or techniques. Further, each data set may contain subsets of data that also may be distinct from other subsets.

As stated above, in various embodiments of system 101, the data can be stored without regard to a common format. However, in one embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier, TXA-ID or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. System 101 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 101 may consist of any combination thereof at a single location or at multiple locations, wherein each database or system includes any of various suitable security features, such as firewalls, access codes, encryption, decryption, compression, decompression, and/or the like.

The system 101 may be interconnected to an external data source 161 (for example, to obtain data from a vendor) via a second network, referred to as the external gateway 163. The external gateway 163 may include any hardware and/or software suitably configured to facilitate communications and/or process transactions between the system 101 and the external data source 161. Interconnection gateways are commercially available and known in the art. External gateway 163 may be implemented through commercially available hardware and/or software, through custom hardware and/or software components, or through a combination thereof. External gateway 163 may reside in a variety of configurations and may exist as a standalone system or may be a software component residing either inside EDMS 150, the external data source 161 or any other known configuration. External gateway 163 may be configured to deliver data directly to system 101 components (such as CAE 147) and to interact with other systems and components such as EDMS 150 databases. In one embodiment, the external gateway 163 may comprise web services that are invoked to exchange data between the various disclosed systems. The external gateway 163 represents existing proprietary networks that presently accommodate data exchange for data such as financial transactions, customer demographics, billing transactions and the like. The external gateway 163 is a closed network that is assumed to be secure from eavesdroppers.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

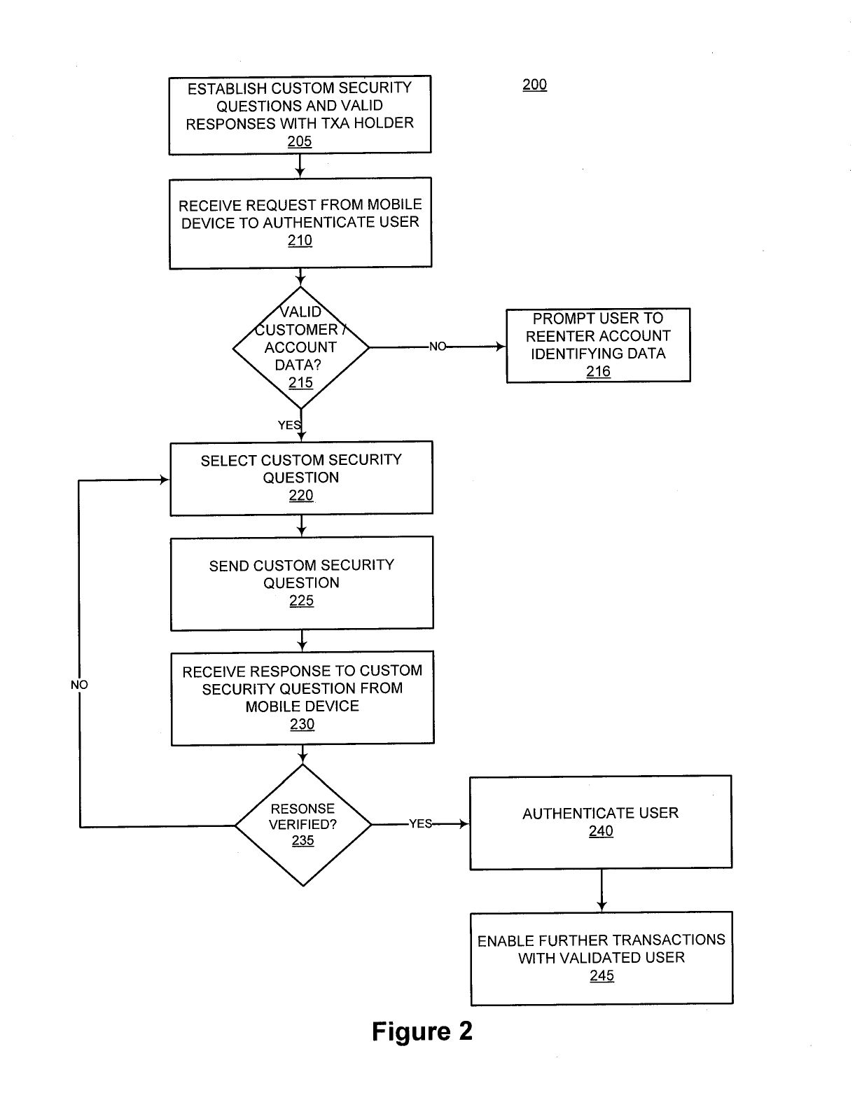

Referring now to the figures, the block system diagrams and process flow diagrams represent mere embodiments of the invention and are not intended to limit the scope of the invention as described herein. For example, the steps recited in FIG. 2 may be executed in any order and are not limited to the order presented. It will be appreciated that the following description makes appropriate references not only to the steps depicted in FIG. 2, but also to the various system components as described above with reference to FIG. 1.

With reference to FIG. 1, in one embodiment, when user 105 logs on to an application, Internet server 125 may invoke an application server 145. Application server 145 invokes logic in the CAE 147 by passing parameters relating to the user's 105 requests for data. The CIS 115 manages requests for data from the CAE 147 and communicates with system 101 components. Transmissions between the user 105 and the Internet server 125 may pass through a firewall 120 to help ensure the integrity of the CIS 115 components. Practitioners will appreciate that the invention may incorporate any number of security schemes or none at all. In one embodiment, the Internet server 125 receives page requests from the mobile web client 110 and interacts with various other system 101 components to perform tasks related to requests from the mobile web client 110.

Internet server 125 may invoke an authentication server 130 to verify the identity of user 105 and assign specific access rights to user 105. In order to control access to the application server 145 or any other component of the CIS 115, Internet server 125 may invoke an authentication server 130 in response to user 105 submissions of authentication credentials received at Internet server 125. When a request to access system 101 is received from Internet server 125, Internet server 125 determines if authentication is required and transmits a prompt to the mobile web client 110. User 105 enters authentication data at the mobile web client 110, which transmits the authentication data to Internet server 125. Internet server 125 passes the authentication data to authentication server which queries the user database 140 for corresponding credentials. When user 105 is authenticated, user 105 may access various applications and their corresponding data sources.

Referring now to FIG. 2, a representative process for using dynamic challenge and response techniques to increase security and customer satisfaction during a customer authentication process is shown. User 105 (i.e. an unauthenticated customer) wishes to gain access to TXA customer interface modules such as a service enrollment module. The customer sets up customized security challenges and valid answers to those challenges (step 205). In one embodiment, the customer is not limited to a predetermined set of security challenges but may also choose to enter any challenge they wish to designate. In one embodiment, the valid answer to the custom security challenge is dynamic. For example, the customer may set up a security challenge that asks for the amount of the most recent transaction to the TXA. Thus, at the time the customer sets up the security challenge (step 205), the valid answer would be designated as the value of the latest transaction stored on TXA database 160. A second example is if the customer sets up a security challenge asking the age of a person familiar to the customer. Thus, the valid answer would be a calculation based upon the birthday entered by the customer in association with this security challenge. In one embodiment, the answer to the security challenge includes biometric data or a biometric sample or samples. In one embodiment, the answer to the security challenge includes information useful for obtaining access to other data sources. For example, a valid answer may include information to access the customer's information on a third-party database, such as, for example a state's department of motor vehicles database.

CAE 147 receives a request to authenticate a user (step 210). The request is accompanied by data that identifies the customer TXA (e.g., an account number and/or a TXA-ID). In one embodiment, CAE 147 prompts the user for identification data and receives a response with the appropriate data. The data that identifies the customer TXA may include data that is unique to the mobile device. CAE 147 uses the customer identifying data to validate the customer-account combination (step 215). When a third-party wishes to access a customer TXA on behalf of the customer, the third-party user submits a different set of identifying data than a customer user. Such data allows CAE 147 to identify the user as a third-party. In the context of this example, the third-party is an agent acting on behalf of the customer. Furthermore, the customer sets up a different set of security challenges to be used in authenticating the third-party.

CAE 147 accesses the various components of CAAS 150 to determine whether the customer identifying data corresponds to the data stored on customer database 155 and/or TXA database 160. If CAE 147 determines that the customer identifying data does not fully or partially match a valid user account then CAE 147 prompts the user to reenter the account identifying data (step 216). If CAE 147 determines (step 215) that the customer identifying data matches a valid user account then the customer authentication process continues. In one embodiment, the customer/account validation process includes matching account identification data, such as an account with additional data such as a TXA-ID.

CAE 147 selects a customer security challenge (step 220). In one embodiment CAE 147 selects more than one security challenge to present to the user at that same time. In one embodiment, CAE 147 selects a security challenge or a series of security challenges based upon the security profile of the service that the customer wishes to access. For example, if a customer wishes to view balance information, the selection of security challenges is different than if the customer wishes to complete a financial transaction. In one embodiment, CAE 147 selects a security challenge, or a series of security challenges based upon, or partially based upon, mobile web client 110 characteristics or capabilities. For instance, CIS 115 detects the type or manufacturer of mobile web client 110 and provides this information to CAE 147 which uses the information to determine what type of security information can be communicated by mobile device 110 and selects a series of security questions accordingly. In one embodiment, CIS 115 determines the location of the mobile device based upon locational information such as, for example, global positioning satellite (GPS) data, and CAE selects security challenges based upon the customer's location. In one embodiment, steps 220, 225, 230 and 235 are repeated as CAE 147 prompts the user one challenge at a time and may select a security challenge based upon the response of a previous challenge. The selection of the security challenge can be random, date driven, event driven, based upon a predetermined selection method or any combination of these selection methods. For example, in one embodiment, the selection of the first security challenge is predetermined based upon user customization and a second security challenge is chosen randomly.

CIS sends the security challenge to the customer via the mobile web client 110 (step 225). In one embodiment, CAE 147 encrypts the customer security challenge and the mobile web client is configured with a custom software module that is unique to the authenticating entity (e.g. a TXA issuer). In one embodiment, the security challenge may be encrypted using the public key associated with the customer's TXA and decrypted using the customer's private key. The mobile web client may be configured with general purpose network interface or Internet browsing software and the format, content and function of the GUI are controlled by CAE 147.

CAE 147 receives the response to the custom security challenge. In one embodiment, the response is encrypted (step 230). CAE 147 accesses the various components of CAAS 150 to determine whether the response corresponds to the valid response stored on the customer database 155 (step 235). As previously discussed, verifying the customer response may include, for example, matching data stored on a database, performing a calculation or other algorithm, accessing other data associated with the customer (e.g. TXA data) or a combination of these matching techniques and other factors. For instance, in one embodiment CAAS 150 accesses information on third-party data sources such as a government database or credit scoring database as part of the response verification step. If the customer response does not correspond to a valid response, CAE 147 selects another customer security challenge (or set of challenges) and the process repeats. In one embodiment, CIS 147 tracks the number of customer authentication attempts and locks the customer account from mobile access if the number of failed attempts exceeds a predetermined threshold.

If the customer response is verified (step 235), CAE 147 authenticates the customer (step 240) and enables the customer to conduct further interaction with TXA issuer systems. For instance, in one embodiment, the mobile web client is configured with a service enrollment application and the successful authentication of the customer allows the customer to enroll in additional services with the TXA issuer. In one embodiment, the successful authentication of the customer (step 245) enables transactions to be executed against the customer's TXA.

In one embodiment, the authentication process authenticates the user for a limited time and/or a limited number of transactions. For example, CAAS 150 may send a security mask proxy identifier to CAE 147 along with the authentication and the proxy identifier is limited to a single charge against a TXA. For further information regarding security mask proxy identifiers see, for example, System And Method For Securing Sensitive Information During Completion Of A Transaction, U.S. Ser. No. 10/708,569, filed on Mar. 11, 2004 and System And Method For Re-Associating An Account Number To Another Transaction Account, U.S. Ser. No. 10/710,484, filed on Jul. 14, 2004, both of which are hereby incorporated by reference.

While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to ‘at least one of A, B, and C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

1-22. (canceled)

23. A method, comprising:
a computer system soliciting a user for a plurality of security questions defined by the user and a plurality of corresponding answers, wherein the user has an account associated with the computer system;
the computer system storing the plurality of security questions and the plurality of corresponding answers;
the computer system receiving, from a mobile device, a request to access account information of the user via the mobile device;
in response to the request, the computer system selecting one or more of the plurality of security questions; and
the computer system sending the selected one or more security questions to the mobile device.

24. The method of claim 23, wherein the computer system selects the one or more security questions based on a type of account information for which access is requested.

25. The method of claim 23, wherein the computer system selects the one or more security questions based on a global positioning system (GPS) location of the mobile device.

26. The method of claim 23, wherein the selecting includes selecting a first of the plurality of security questions based on an answer provided by the user for a second of the plurality of security questions.

27. The method of claim 23, wherein the plurality of corresponding answers include an answer that is dynamic.

28. The method of claim 23, further comprising:
the computer system receiving one or more answers corresponding to the one or more security questions; and
the computer system comparing the one or more answers with one or more of the plurality of corresponding answers.

29. A non-transitory computer readable medium having program instructions stored therein, wherein the program instructions are executable by a computer system to cause the computer system to perform operations comprising:
receiving a set of security challenges defined by a user having an account associated with the computer system;
receiving a set of answers defined by the user and corresponding to the set of security challenges;
receiving, from a client device, a request to access the account of the user; and
in response to the request, selecting one or more of the security challenges to transmit to the client device.

30. The non-transitory computer readable medium of claim 29, wherein the request is received with a global positioning system (GPS) location of the client device, and wherein the one or more security challenges are selected based on the location.

31. The non-transitory computer readable medium of claim 29, wherein the selecting is based on a type of account information identified in the request.
